(19) United States
(12) Patent Application Publication
(10) Pub. No.: US 2024/0251416 A1
(43) Pub. Date: Jul. 25, 2024

(54) METHOD AND APPARATUS FOR UPLINK TRANSMISSION USING MULTIPLE CODEWORDS

(71) Applicant: Electronics and Telecommunications Research Institute, Daejeon (KR)

(72) Inventors: Cheul Soon KIM, Daejeon (KR); Young-jo KO, Daejeon (KR); Sung Hyun MOON, Daejeon (KR); Jung Hoon LEE, Daejeon (KR)

(73) Assignee: Electronics and Telecommunications Research Institute, Daejeon (KR)

(21) Appl. No.: 18/417,689

(22) Filed: Jan. 19, 2024

(30) Foreign Application Priority Data
Jan. 20, 2023 (KR) 10-2023-0009063
Sep. 18, 2023 (KR) 10-2023-0124286

(51) Int. Cl. H04W 72/21; H04L 5/00; H04W 72/044; H04W 72/1268

(52) U.S. Cl. CPC H04W 72/21; H04L 5/0051; H04W 72/0466; H04W 72/1268

(57) ABSTRACT

A method of a terminal may comprise: generating uplink control information (UCI); receiving scheduling information for transmission of a physical uplink shared channel (PUSCH) including a first transport block (TB) and a second TB; selecting codeword(s) with which the UCI is to be multiplexed from among a codeword according to the first TB and a codeword according to the second TB; and transmitting the PUSCH in which the selected codeword(s) and the UCI are multiplexed.

### CROSS-REFERENCE TO RELATED APPLICATIONS

This application claims priority to Korean Patent Applications No. 10-2023-0009063, filed on Jan. 20, 2023 and No. 10-2023-0124286 filed on Sep. 18, 2023 with the Korean Intellectual Property Office (KIPO), the entire contents of which are hereby incorporated by reference.

### BACKGROUND

### 1. Technical Field

Exemplary embodiments of the present disclosure relate to an uplink transmission method and more specifically, to a method and an apparatus for performing uplink transmission by using multiple codewords.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

The 5G communication system (e.g. communication system supporting the NR) using a higher frequency band (e.g. frequency band of 6 GHz or above) than a frequency band (e.g. frequency band of 6 GHz or below) of the 4G communication system is being considered for processing of wireless data soaring after commercialization of the 4G communication system (e.g. communication system supporting the LTE). The 5G communication system can support enhanced mobile broadband (eMBB), ultra-reliable low-latency communication (URLLC), massive machine type communication (mMTC), and the like. Discussion on a sixth generation (6G) communication system after the 5G communication system is in progress.

Meanwhile, in the 5G communication system, discussions are underway on various techniques for performing uplink transmission using two or more transmission panels (Tx panels) in a terminal. In particular, active discussions are underway regarding transmission of a physical uplink shared channel (PUSCH) including two or more codewords.

### SUMMARY

Exemplary embodiments of the present disclosure are directed to providing a method and an apparatus for performing uplink transmission using multiple codewords.

According to a first exemplary embodiment of the present disclosure, a method of a terminal may comprise: generating uplink control information (UCI); receiving scheduling information for transmission of a physical uplink shared channel (PUSCH) including a first transport block (TB) and a second TB; selecting codeword(s) with which the UCI is to be multiplexed from among a codeword according to the first TB and a codeword according to the second TB; and transmitting the PUSCH in which the selected codeword(s) and the UCI are multiplexed.

The PUSCH may be transmitted using five or more layers.

The selected codeword(s) may be one codeword selected by the scheduling information.

The one codeword may be selected by: deriving a spectral efficiency of the first TB and a spectral efficiency of the second TB from the scheduling information; and selected a codeword associated with a TB with a higher spectral efficiency among the spectral efficiency of the first TB and the spectral efficiency of the second TB as the one codeword.

When the spectral efficiency of the first TB and the spectral efficiency of the second TB are same, a codeword associated with the first TB may be selected as the one codeword.

When the first TB or the second TB is initially transmitted, the spectral efficiency of the first TB or the second TB may be determined based on the scheduling information for transmission of the PUSCH, and when the first TB or the second TB is retransmitted, the spectral efficiency of the first TB or the second TB may be determined based on scheduling information for a PUSCH initially transmitted for the first TB or the second TB.

According to a second exemplary embodiment of the present disclosure, a method of a terminal may comprise: generating uplink control information (UCI); receiving scheduling information for transmission of a physical uplink shared channel (PUSCH) including at least one transport block (TB); selecting codeword(s) with which the UCI is to be multiplexed from among codeword(s) according to the at least one TB; determining first PUSCH demodulation-reference signal (DM-RS) port(s) to be used for transmission of the at least one TB and second PUSCH DM-RS port(s) to be used for transmission of the UCI; and transmitting the PUSCH in which the selected codeword(s) and the UCI are multiplexed by using the determined first PUSCH DM-RS port(s) and second PUSCH DM-RS port(s).

The PUSCH may be transmitted using five or more layers and corresponds to one sounding reference signal (SRS) resource having eight ports, and each port of the PUSCH may be preprocessed identically to each corresponding port in the SRS resource.

The at least one TB may include a first TB and a second TB, the first PUSCH DM-RS port(s) may be divided into a first subset including first-first DM-RS port(s) to which the codeword corresponding to the first TB is mapped and a second subset including first-second DM-RS port(s) to which the codeword corresponding to the second TB is mapped, an intersection of the first subset and the second subset may be an empty set, and the second PUSCH DM-RS port(s) may be the first-first PUSCH DM-RS port(s) or the first-second PUSCH DM-RS port(s).

Coherence may be maintained in all or a subset of the first PUSCH DM-RS port(s).

Coherence may be maintained in all or a subset of {0, 1, 4, 5} among the first PUSCH DM-RS port(s), and coherence may be maintained in all or a subset of {2, 3, 6, 7} among the first PUSCH DM-RS port(s).

Coherence may be maintained in all or a subset of {0, 1} among the first PUSCH DM-RS port(s), coherence may be maintained in all or a subset of {2, 3} among the first PUSCH DM-RS port(s), coherence may be maintained in all or a subset of {4, 5} among the first PUSCH DM-RS port(s), and coherence may be maintained in all or a subset of {6, 7} among the first PUSCH DM-RS port(s).

When the at least one TB is one TB, the first PUSCH DM-RS port(s) and the second PUSCH DM-RS port(s) may be all PUSCH DM-RS ports indicated by the scheduling information.

According to a third exemplary embodiment of the present disclosure, a terminal may comprise: a processor; and a transceiver, and the processor may be configured to perform: generating uplink control information (UCI); receiving, through the transceiver, scheduling information for transmission of a physical uplink shared channel (PUSCH) including at least one transport block (TB); selecting codeword(s) with which the UCI is to be multiplexed from among codeword(s) according to the at least one TB; determining first PUSCH demodulation-reference signal (DM-RS) port(s) to be used for transmission of the at least one TB and second PUSCH DM-RS port(s) to be used for transmission of the UCI; and transmitting, through the transceiver, the PUSCH in which the selected codeword(s) and the UCI are multiplexed by using the determined first PUSCH DM-RS port(s) and second PUSCH DM-RS port(s).

The PUSCH may be transmitted using five or more layers and corresponds to one sounding reference signal (SRS) resource having eight ports, and each port of the PUSCH may be preprocessed identically to each corresponding port in the SRS resource.

The at least one TB may include a first TB and a second TB, the first PUSCH DM-RS port(s) may be divided into a first subset including first-first DM-RS port(s) to which the codeword corresponding to the first TB is mapped and a second subset including first-second DM-RS port(s) to which the codeword corresponding to the second TB is mapped, an intersection of the first subset and the second subset may be an empty set, and the second PUSCH DM-RS port(s) may be the first-first PUSCH DM-RS port(s) or the first-second PUSCH DM-RS port(s).

Coherence may be maintained in all or a subset of the first PUSCH DM-RS port(s).

Coherence may be maintained in all or a subset of {0, 1, 4, 5} among the first PUSCH DM-RS port(s), and coherence may be maintained in all or a subset of {2, 3, 6, 7} among the first PUSCH DM-RS port(s).

Coherence may be maintained in all or a subset of {0, 1} among the first PUSCH DM-RS port(s), coherence may be maintained in all or a subset of {2, 3} among the first PUSCH DM-RS port(s), coherence may be maintained in all or a subset of {4, 5} among the first PUSCH DM-RS port(s), and coherence may be maintained in all or a subset of {6, 7} among the first PUSCH DM-RS port(s).

When the at least one TB is one TB, the first PUSCH DM-RS port(s) and the second PUSCH DM-RS port(s) may be all PUSCH DM-RS ports indicated by the scheduling information.

According to exemplary embodiments of the present disclosure, uplink transmission with multiple codewords can be performed efficiently. In particular, according to exemplary embodiments of the present disclosure, UCI can be multiplexed to a PUSCH having multiple codewords by considering effective code rates and spectral efficiencies. In addition, according to exemplary embodiments of the present disclosure, UCI can be multiplexed in a PUSCH having a single codeword by considering various factors. Accordingly, the performance of the overall communication system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating the order of ports according to an example of antenna array analysis.

FIG. 4 is a conceptual diagram illustrating the order of ports according to another example of antenna array analysis.

FIGS. 5A, 5B, 6A, 6B, 7A, 7B, 8A, 8B, 9A, 9B, 10A, 10B and 11 are conceptual diagrams illustrating examples of various port mappings considering an arrangement of antenna array and positions of antenna ports thereof.

FIG. 12 is a flow chart illustrating a method of transmitting a PUSCH including two codewords according to an exemplary embodiment of the present disclosure.

FIG. 13 is a flow chart illustrating a method of transmitting a PUSCH including one codeword or multiple codewords according to an exemplary embodiment of the present disclosure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

In exemplary embodiments, ‘configuration of an operation (e.g. transmission operation)’ may mean ‘signaling of configuration information (e.g. information element(s), parameter(s)) for the operation’ and/or ‘signaling of information indicating performing of the operation’. ‘Configuration of information element(s) (e.g. parameter(s))’ may mean that the corresponding information element(s) are signaled. The signaling may be at least one of system information (SI) signaling (e.g. transmission of system information block (SIB) and/or master information block (MIB)), RRC signaling (e.g. transmission of RRC message(s), RRC parameter(s) and/or higher layer parameter(s)), MAC control element (CE) signaling (e.g. transmission of a MAC message and/or MAC CE), PHY signaling (e.g. transmission of downlink control information (DCI), uplink control information (UCI), and/or sidelink control information (SCI)), or a combination thereof.

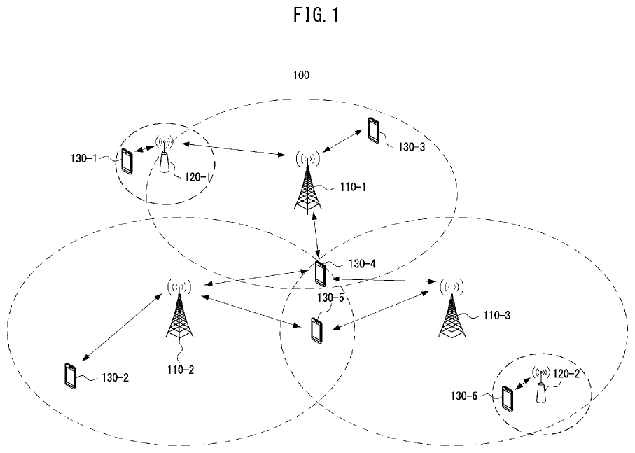

FIG. 1 is a conceptual diagram illustrating a first exemplary embodiment of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g. serving-gateway (S-GW), packet data network (PDN)-gateway (P-GW), and mobility management entity (MME)). When the communication system 100 is the 5G communication system (e.g. NR system), the core network may include an access and mobility management function (AMF), a user plane function (UPF), a session management function (SMF), and the like.

The plurality of communication nodes 110 to 130 may support the communication protocols (e.g. LTE communication protocol, LTE-A communication protocol, NR communication protocol, etc.) defined by technical specifications of 3rd generation partnership project (3GPP).

The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may have the following structure.

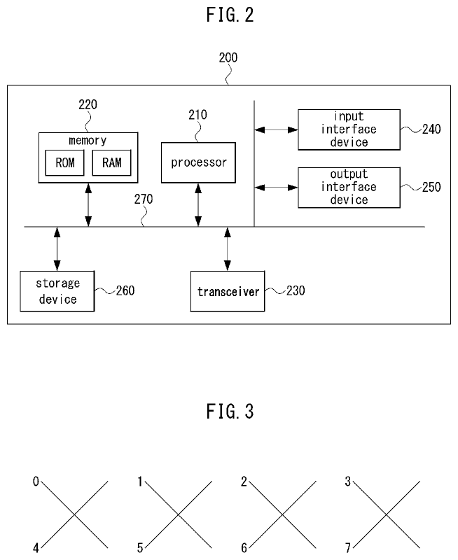

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may be connected to the processor 210 via an individual interface or a separate bus, rather than the common bus 270.

For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), an advanced base station (BTS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication system will be described. Even when a method (e.g. transmission or reception of a data packet) performed at a first communication node among communication nodes is described, the corresponding second communication node may perform a method (e.g. reception or transmission of the data packet) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

In order to reduce an error rate of data, a low modulation and coding scheme (MCS) level (or, low MCS index) may be applied. In order not to increase a size of a field indicated by downlink control information (DCI), frequently used MCS(s) may be selected. In order to apply a lower MCS, a repeated transmission operation may be supported. In case of applying a quadrature phase shift keying (QPSK) which is the lowest modulation rate, an effect of further reducing the code rate may occur. In particular, since a transmit power is limited in uplink (UL) transmission, the repeated transmission operation may be performed in the time domain rather than in the frequency domain.

In the case of eMBB traffic and URLLC traffic, a lower MCS may be used for different purposes, respectively. For example, for eMBB traffic, a lower MCS may be required to extend a coverage. On the other hand, for URLLC traffic, a lower MCS may be required to reduce a latency and achieve a lower error rate. Since the requirements are different, the eMBB traffic may be repeatedly transmitted even when a relatively large latency occurs. The URLLC traffic may be transmitted using new MCSs (e.g. low MCS) rather than the repeated transmission. The new MCS may be configured by an RRC message and/or a DCI.

In order to support repeated transmissions for the eMBB traffic in the time domain, a physical uplink shared channel (PUSCH) repetition (e.g. PUSCH repetition type A) may be introduced. In this case, a PUSCH allocated on a slot basis may be repeatedly transmitted. To extend a coverage, a time resource may be allocated over a plurality of slots. When the PUSCH repetition type A is used, the time resource may be configured by an RRC message and/or a DCI.

The number of repetitions of the PUSCH may be indicated by the RRC message, and a time resource for transmitting the PUSCH in the first slot may be indicated by the DCI (e.g. in case of type 2 configured grant (CG) or dynamic grant) or the RRC message (e.g. in case of type 1 CG).

Since a latency occurs when the URLLC traffic is repeatedly transmitted, it may not be appropriate to repeatedly transmit the URLLC traffic. However, when a sufficiently low MCS is used, a latency for decoding the URLLC traffic may be reduced. That is, when a sufficiently low MCS is used, the number of resource elements (REs) to which the URLLC traffic is mapped may increase, and the base station (e.g. a decoder of the base station) should wait until all the REs are received. In this case, the latency for decoding the URLLC traffic may be reduced.

However, when a PUSCH to which a rather high MCS is applied is repeatedly transmitted, the base station may perform the decoding only with some REs. Therefore, a timing at which decoding is successful in the repeated PUSCH transmission (e.g. repeated transmission of the PUSCH to which a somewhat high MCS is applied) may be earlier than a timing at which decoding is successful in the non-repeated PUSCH transmission (e.g. transmission of the PUSCH to which a low MCS is applied). When the PUSCH repetition type A is used, an unnecessary latency may occur, and a PUSCH repetition type B may be introduced to reduce the latency due to the repeated transmission. When the PUSCH repetition type B is used, a PUSCH allocated on a mini-slot basis may be repeatedly transmitted. When the PUSCH repetition type B is used, a time resource may be configured by an RRC message and/or DCI. A combination of a reference time resource of a PUSCH instance and the number of repeated transmissions may be indicated by the DCI (e.g. in case of Type 2 CG and/or dynamic grant) or the RRC message (e.g. in case of Type 1 CG).

In order to control a transmission power of a sounding reference signal (SRS) resource indicated by an SRS resource indicator (SRI), the base station may estimate a path loss for each SRS resource. The base station may control a transmission power of SRS resource(s) by using DCI. The transmission power of the SRS resource(s) may be controlled based on the estimated path loss. The DCI may be scheduling DCI (e.g. DCI format 0_0, DCI format 0_1, DCI format 0_2, DCI format 1_0, DCI format 1_1, or DCI format 1_2) or group-common (GC)-DCI (e.g. DCI format 2_2 or DCI format 2_3). The DCI may include a field indicating a transmit power control (TPC) command, and the TPC command may be used to control a transmission power of the terminal. For example, the transmission power of the terminal may be increased or decreased based on the TPC command included in the DCI. In order to determine a transmission power of a PUSCH, the terminal may consider a value obtained based on a path loss, a value according to the TPC command included in the DCI, and/or a PUSCH bandwidth indicated by the DCI.

The base station may configure two or more sets to the terminal using higher layer signaling. The terminal may receive configuration information of the two or more sets from the base station. Element(s) constituting each of the two or more sets may be transmission power parameter(s), and may be indicated to be suitable for different scenarios (e.g. URLLC scenario, eMBB scenario). The terminal may receive scheduling DCI or activating DCI for allocating a PUSCH resource from the base station, and the scheduling DCI or the activating DCI may indicate a set for interpreting transmission power parameter(s). When a set of transmission power parameter(s) is different, a magnitude of increasing or decreasing the transmission power indicated by the same TPC command may be different.

When Type 1 CG or Type 2 CG is used, a transmission power may be determined based on a DCI format 2_3 for an SRI associated with a PUSCH instance. When Type 2 CG is used, activating DCI may indicate a set of transmission power parameter(s) applied to a PUSCH occasion. The PUSCH occasion may mean a PUSCH instance. The terminal may obtain a TPC command for an SRI by receiving GC-DCI, and may interpret the TPC command to be suitable to the set of transmission power parameter(s) indicated by the base station, and may derive a transmission power to be applied to the PUSCH instance based on a result of the interpretation.

In transmitting a dynamically-scheduled PUSCH, the terminal may derive a transmission power applied to a PUSCH instance based on a combination of GC-DCI and scheduling DCI.

By receiving the GC-DCI, the terminal may identify a TCP command of an SRI and store the identified TCP command. In transmitting a dynamically-scheduled PUSCH, a set of transmission power parameter(s) and/or a TPC command applied to a PUSCH occasion may be indicated by scheduling DCI. The terminal may derive a transmission power to be applied to a PUSCH instance based on a transmission power of an SRI associated with the PUSCH instance.

Repeated HARQ-ACK transmission may be indicated (or configured) by higher layer signaling for each physical uplink control channel (PUCCH) format. The number of repeated transmissions for a PUCCH format i may be independently set. i may be 1, 3, or 4. The terminal may repeatedly transmit a PUCCH format through slots. In this case, the PUCCH format may be transmitted using the same time resource in the respective slots.

The type of uplink control information (UCI) may be classified according to a type of information included in the UCI. The UCI may include at least one of a scheduling request (SR), L1-reference signal received power (L1-RSRP), HARQ-ACK, channel state information (CSI), or combinations thereof. In exemplary embodiments, UCI and UCI type may be used with the same meaning. In a repeated transmission operation of UCI, only one UCI type may be transmitted. In order to support this operation, a priority of each UCI type may be defined in the technical specification. One UCI type may be selected, and a PUCCH including the one UCI type may be repeatedly transmitted. In this case, the terminal may assume that no other UCI type is transmitted before the transmission of the corresponding UCI type is completed. In order to support this operation, the base station may instruct the terminal to transmit UCI (e.g. SR or HARQ-ACK) after transmission of the corresponding PUCCH is completed. A waiting time for the UCI transmission may be large, and the waiting time may act as a constraint on scheduling of the base station.

When it is indicated to transmit HARQ-ACKs in the same slot (or the same subslot) or when PUCCH time resources indicated by DCI(s) and/or RRC message(s) for allocating physical downlink shared channel(s) (PDSCH(s)) overlap each other, the terminal may generate a HARQ codebook so as to be transmitted on one PUCCH (e.g. one PUCCH time resource). In the HARQ codebook, HARQ-ACK bits may be arranged according to an order defined in the technical specification. Information bits may be generated by the above-described operation. The terminal may generate coded bits by performing an encoding operation thereon.

In the encoding operation, a Reed-Muller code or a polar code may be used. A code rate applied in the encoding operation may be indicated by higher layer signaling. For example, one value in the PUCCH format may be the code rate and may be indicated to the terminal.

One codeword may be mapped to one PUCCH. In a repeated PUCCH transmission operation, one UCI type may be generated as a codeword. When a PUCCH is transmitted once, information bits of one UCI type or two or more UCI types may be concatenated, and the terminal may generate one codeword by performing the same encoding operation on the information bits. When a Reed-Muller code or a polar code is used, it may be difficult to implement a soft combining operation. Accordingly, even when the PUCCH is repeatedly transmitted, the same codewords may be transmitted, and the base station may perform a chase combining operation on the same codewords. The coded bit or codeword may mean a bit stream in which a plurality of code blocks are concatenated. A modulation operation may be performed on the codeword, and a result of the modulation operation may be mapped to resource elements (REs).

Meanwhile, the same UCI types may be regarded as different information. The same UCI types considered as different information may be mapped. For example, UCIs may be generated to support traffic having different priorities. A UCI (e.g. SR or HARQ-ACK) supporting eMBB traffic may be regarded as information different from a UCI (e.g. SR or HARQ-ACK) supporting URLLC traffic. In this case, even when the UCI types are the same, they may be distinguished as different information.

The coded UCI may be mapped to a PUCCH. In a PUCCH transmission operation, the same preprocessing scheme (e.g. spatial information, spatial relation) may be maintained. Alternatively, in the PUCCH transmission operation, use of a different preprocessing scheme for each PUCCH may be allowed by RRC signaling of the base station.

In order to support URLLC traffic, it may be preferable for the terminal to perform frequent reception operations in downlink (DL) resources and/or frequent transmission operations in uplink (UL) resources. In a time division duplex (TDD) system, the terminal may operate based on a half-duplex scheme. Accordingly, a time of supporting DL traffic and/or UL traffic may increase according to a slot pattern. On the other hand, in a frequency division duplex (FDD) system, the terminal may utilize DL resources and UL resources at the same time.

Accordingly, the above-described problem in the TDD system may not occur in the FDD system. The FDD system may use two or more carriers. When two or more serving cells are configured to the terminal in the TDD system, the terminal may utilize DL resources and UL resources.

In a communication system including at least one carrier to which the FDD is applied (hereinafter, referred to as ‘FDD carrier’), there may be no problem with respect to a latency of the terminal. In a communication system including only carrier(s) to which the TDD is applied (hereinafter, referred to as ‘TDD carrier(s)’), there may be a problem with respect to a latency of the terminal. In order to solve the above problem, slots in the TDD carriers may be configured according to different patterns.

Carrier aggregation (CA) may be configured in the terminal, and a PCell and SCell(s) may be activated. Depending on whether a common search space (CSS) set is included, a cell may be classified into a PCell or an SCell. For example, the PCell may include a CSS set, and the SCell may not include a CSS set. In order to reduce a latency in a communication system supporting URLLC traffic, slots having different patterns may be configured and/or indicated to the terminal.

The eMBB traffic or URLLC traffic may be supported in a licensed band, but may also be supported in an unlicensed band. Carrier(s) belonging to a licensed band or carrier(s) belonging to an unlicensed band may be used alone, but depending on configuration of the base station, all of the carrier(s) belonging to the licensed band and the carrier(s) belonging to the unlicensed band may be utilized through frequency aggregation.

In exemplary embodiments, two or more terminals may receive data from one or more TRPs, and may transmit data to one or more TRPs. It may be assumed that one base station or one server performs a management operation and/or a scheduling operation for one or more TRPs among a plurality of TRPs. The TRPs may be directly connected with each other. Alternatively, the TRPs may be connected through the base station. The above-described connections may be connections according to Xn interfaces or wireless interfaces (e.g. interfaces of the 3GPP NR).

A shadow area may occur between areas supported by the TRPs. Therefore, the TRPs may resolve the shadow area through cooperative transmissions. The cooperative transmissions may be performed for a terminal located between the TRPs. Even when a shadow area does not occur, a quality of radio links may be improved by installing many TRPs (or base stations) to transmit and receive a lot of data.

According to a cooperative transmission and a cooperative reception of the TRPs, a communication scheme may be classified into dynamic point selection (DPS) and joint transmission (JT). For a specific physical resource block (PRB) set, the DPS may be a scheme of receiving data through one TRP, and the JT may be a scheme of receiving data through two or more TRPs. A dynamic point blanking (DPB) scheme may be a type of the JT. When the DPB is used, the terminal may not receive data from some TRPs and may receive data from the remaining TRPs. The JT may be classified into coherent JP and noncoherent JP. Depending on whether a coherent combining operation is performed on signals received from TRPs, the coherent JP or the non-coherent JP may be used.

Depending on a latency and traffic allowance of a backhaul network to which the base stations or TRPs are connected, the TRPs may or may not participate in cooperative transmission and reception in real time. The terminal may support JT through one DCI (i.e. single DCI (sDCI)). Alternatively, the terminal may support JT through multiple DCIs (i.e. multi-DCI (mDCI)).

In case of using sDCI, the terminal may transmit and receive data with TRPs. In case of using sDCI, it may be preferable for TRPs to be able to cooperate through the backhaul network without a latency. In case of using mDCI, the terminal may transmit and receive data with some TRPs. When the terminal transmits and receives data with other TRPs, it is difficult for these TRPs to cooperate in real time through the backhaul network, so it may be preferable to allocate semi-static resources to these TRPs.

In the existing technical specifications, a CORESET pool index has been introduced to identify a TRP. A CORESET pool is a set of CORESETs, and a transmission configuration indication (TCI) state applied to each CORESET may be independently indicated to the terminal through RRC signaling and/or MAC control element (CE) signaling. Therefore, a CORESET pool index may not necessarily correspond to a TRP. More specifically, if a TRP is classified into a transmission point (TxP) and a reception point (RxP), a CORESET pool index may correspond to an RxP. For example, an Rx beam received from a TxP may be derived from a TCI state, and uplink signals/channels scheduled by DCIs detected in CORESETs belonging to a CORESET pool indicated by one CORESET pool index may be interpreted as being received from the same RxP.

In order for a terminal to obtain a gain through coherent combining, there needs to be a certain degree of synchronization between TRPs for the terminal, and CSI reports for the TRPs need also to be shared. In case where these are not possible, it is advantageous in terms of performance to perform noncoherent combining in the terminal.

When a terminal is mounted on a vehicle, restrictions on the size and weight of the terminal may be relaxed. However, in case of a terminal carried by a person, portability of the terminal may be taken into consideration.

Small cells or IAB nodes may be deployed to extent signal's reach. A throughput of a small cell or IAB node may be affected by a quality of a backhaul link, and securing the backhaul network may be expensive. As an alternative to this, a wireless relay device may be deployed to deliver higher quality signals to the terminal. The wireless relay devices may be classified into several types depending on a method of delivering signals. As a wireless relay device supports more functions, it can show performance similar to that of a base station, and as a wireless relay device supports fewer functions, it can be deployed at a lower cost. The wireless relay device considered in the present disclosure may perform a function of forming beams to terminals, but may perform a minimum function of transmitting data. The base station needs to transmit wireless signals to control these wireless relay devices. Appropriate parameters for the wireless relay device may be configured using these wireless signals.

Hereinafter, a method for a terminal to transmit an uplink signal/channel using two or more transmission panels (Tx panels) simultaneously (e.g. Simultaneous Transmission across Multiple Panels (STxMP)) will be described. The following descriptions may be primarily applied to PUSCH transmission, but may also be applied as they are to sounding reference signal (SRS) transmission and/or PUCCH transmission, or easily modified for SRS transmission and/or PUCCH transmission.

Since scheduling information for a PUSCH indicates SRS resource(s) (i.e. SRS resource indicator(s) (SRI(s))) to the terminal, the terminal may use only one transmission panel or use multiple transmission panels simultaneously to perform uplink transmission indicated by the SRI(s). That is, according to the existing technical specifications, since radio resource(s) are indicated by SRS port(s) or DM-RS port(s), the terminal may operate independently of the transmission panels. That is, in terms of implementation, the terminal may perform STxMP transmission or may perform transmission using only one transmission panel.

If the base station knows that the terminal supports STxMP transmission through the terminal's capability signaling, the base station may configure two or more SRS resource sets to the terminal through RRC signaling. Each SRS resource set may include one or more SRS resources. One SRS resource set may correspond to one transmission panel of the terminal.

In case of codebook-based PUSCH transmission, one SRS resource may correspond to a radio link from the terminal's transmission panel to an RxP. When the base station utilizes multiple RxPs, the base station may configure an SRS resource set including multiple SRS resources to the terminal through RRC signaling. The number of PUSCH DM-RS ports for PUSCH transmission may be derived from the number of ports of the indicated SRS resource.

In case of non-codebook-based PUSCH transmission, an SRS resource may correspond to a Tx beam of a radio link from the transmission panel to an RxP. Each SRS resource may have one port.

An SRS resource may have one or more ports, and depending on configuration of the base station, an SRS resource may have up to eight ports. Since the base station can estimate an uplink using the SRS resource, the base station may derive a precoding that PUSCH DM-RS(s) should have or a pairing (i.e. multi-user pairing) of terminals participating in MU-MIMO in terms of implementation. A combination of ports for the SRS resource may be indicated to the terminal through scheduling information, and the terminal may derive characteristics of the PUSCH DM-RS port(s) based on the combination of the indicated ports. For example, some ports belonging to the SRS resource may belong to the same coherence group. In this case, PUSCH DM-RS ports respectively corresponding to the ports of the SRS resource may belong to the same coherence group. Therefore, the technical specifications may specify properties or relationship of the ports of the SRS resource, and these properties or relationships may also be established in the corresponding PUSCH DM-RS ports. The ports of the SRS resource may correspond to the PUSCH DM-RS ports in one-to-one manner, so that a coherence group may be established even between the PUSCH DM-RS ports. For a precoding applied to perform PUSCH transmission, a TPMI should be indicated, taking into account the coherence group of the PUSCH DM-RS port(s).

The terminal may be configured with one or more SRS resource sets from the base station through RRC signaling. The one or more configured SRS resource sets may be referred to as quasi-co-location(s) (QCL(s)) or TCI state(s) of Tx beam(s) for PUSCH transmission. One or two or more TCI states for PUSCH transmission may be indicated, and when the PUSCH transmission is performed in a time division multiplexing (TDM) scheme with two or more RxPs, the indicated TCI states may respectively correspond to Tx beams of radio links for the RxPs.

Similarly, one or more TPMIs may be indicated to the terminal, and when PUSCH transmission is performed in the TDM scheme with two or more RxPs, the indicated TPMIs may respectively correspond to Tx beams of radio links for the RxPs.

The terminal may transmit up to four data layers using one codeword. A MAC layer of the base station may deliver two transport blocks (TBs) to a PHY layer thereof, and the PHY layer may encode each TB to generate a codeword. A PDSCH or PUSCH may be transmitted through data layers corresponding to up to eight DM-RS ports. When five or more layers are used, two codewords may be mapped to the PDSCH or PUSCH.

The terminal may have one or two transmission panels, and each transmission panel may have four or fewer ports. Mathematically, up to eight ports are supported, but the existing technical specifications support no more than four DM-RS ports. The terminal indicated to perform codebook-based PUSCH transmission may use one transmission panel according to the indication from the base station. The terminal indicated to perform non-codebook based PUSCH transmission may use one or more transmission panels according to the indication from the base station.

Hereinafter, exemplary embodiments of codeword-to-layer mapping and antenna port mapping for spatial multiplexing will be described. In particular, an operation method of a terminal when a PUSCH using eight or less DM-RS ports is scheduled will be described.

According to the existing technical specifications, a PDSCH may be scheduled to use eight or less DM-RS ports. According to Table 1 to be described later, when using four or less layers, one TB may be mapped to the PDSCH, and when using five or more layers, two TBs may be mapped to the PDSCH. This scheme may be applied also to PUSCH transmission.

One or more SRS resource sets may be indicated to the terminal through RRC signaling, and the use of the SRS resource set(s) may be indicated by a codebook through RRC signaling.

Scheduling information of a PUSCH may indicate SRS resource indicator(s) (SRI(s)) and transmit precoding matrix indicator(s) (TPMI(S)), and the scheduling information may further indicate precoding information and the number of layers. An SRS resource may be selected by the SRI, or when only one SRS resource belongs to the SRS resource set, the SRI(s) may be omitted. The TPMI may be used to derive a precoding applied to layers 0, 1, . . . , v−1 (here, v is the number of layers), and the derived precoding may correspond to the SRS resource. A codebook for the precoding may have one or more ports, which can be derived using information obtained from the number of ports (e.g. 1, 2, 4, or 8) that the SRS resource has.

Considering the capability of the terminal related to coherence between ports, one of fullyAndPartialAndNonCoherent, partialAndNonCoherent, or nonCoherent may be indicated to the terminal through RRC signaling. For codebook-based PUSCH transmission, the terminal may be indicated a codebook subset through RRC signaling. Additionally, the terminal may be indicated additional information (Ng or CodebookType) that is used to configure a set of ports through RRC signaling.

If the SRS resource is indicated by the scheduling information of the PUSCH, the terminal may assume that the port(s) for transmitting the PUSCH and the port(s) of the SRS resource are the same. Here, code division multiplexing (CDM) may be applied to \tilde{p}₀, . . . , \tilde{p}ᵥ₋₁ corresponding to the DM-RS ports.

The codeword may be converted into modulation symbol(s) through a modulation procedure, and the modulation symbol(s) may be mapped to v layers through a layer mapping procedure. The DM-RS ports and the respective layers are multiplexed, and the same TPMI may be applied thereto through a precoding procedure.

Each port to which precoding is applied may be preprocessed and transmitted in the same manner as each port of the SRS resource associated therewith based on the scheduling information of the PUSCH. Accordingly, the port(s) through which the PUSCH is transmitted are the same as the port(s) of the SRS resource, and the number of port(s) of the PUSCH may be the same as the number of port(s) of the SRS resource. For example, the SRS resource may be configured to have one, two, four, or eight pods, and the port(s) the SRS resource may be indexed as 1000, (1000 and 1001), (1000, . . . , and 1003), or (1000, . . . , and 1007).

The terminal may have at least one transmission panel, but if the terminal has the capability to transmit eight layers simultaneously, ‘maximum number of codewords’ and Ng may be derived. Here, ‘maximum number of codewords’ may be 1 or 2. In order to support transmission using eight layers, it may be preferable that ‘maximum number of codewords’ is indicated as 2.

The value of Ng may be derived as one of at least {1,2,4}. Alternatively, the base station may indicate the value of Ng to the terminal through a higher layer signaling. When a maximum of 8 PUSCH layers can be transmitted, a value of 8/Ng may indicate the maximum number of ports that can be scheduled from one port group. When Ng is derived as 1, the terminal may be interpreted as having one transmission panel, and one transmission panel may perform transmission using up to eight DM-RS ports.

According to the existing technical specifications, Ng may not be separately configured to the terminal but may be implicitly indicated through codebook subset restriction, SRS resource set, and/or configuration of SRS resources. For convenience of description, the number of layers scheduled for a transmission panel i (i∈{1, 2} or i∈{1, 2, 3, 4}) may be expressed as Nᵢ. Alternatively, the number of layers scheduled for an i-th coherence pair (or port group) of the DM-RS ports may be expressed as Nᵢ.

When two TBs (i.e. q=0, q=1) can be scheduled, the interpretation according to Ng may vary. In order to apply methods to be described later, Method 1 may be considered first.

Method 1 is a principle used to extend the existing technical specifications, and Method 1 is preferably applied when Nᵢ≤4 is satisfied.

Method 1: One TB may be mapped to up to four layers and/or ports.

Once Nᵢ is determined, a port combination of PUSCH DM-RS ports may be determined based on Table 1 supported by the existing technical specifications. When considering transmission panel(s), it may be preferable to introduce layer combinations and DM-RS port combinations that are not supported by the existing technical specifications.

When Ng is derived as 2, the terminal may be interpreted as having two transmission panels, and valid combinations of (N₁, N₂) may be limited. Here, a case where the terminal uses two or more transmission panels at the same time is considered.

As an example, a case where N_{L}=N₁+N₂=5 may be considered. According to the existing technical specifications expressed in Table 1, this case may be interpreted as a case where Ng=1 is implied, so (N₁, N₂)=(2,3), (3,2) may be supported.

Method 2: (N₁, N₂)=(1,4), (2,3), (3,2), (4,1) may be supported. Alternatively, (N₁, N₂)=(1,4), (2,3) may be supported.

The terminal may support a case where one layer is transmitted from one transmission panel (or port group) and four layers are transmitted in another transmission panel (or port group). Method 2 may provide scheduling flexibility according to fading characteristics of a radio channel. That is, Method 2 may provide flexibility to enable scheduling appropriate for a rank of the radio channel between the terminal and the base station (or RxP(s)).

As another example, a case where N_{L}=N₁+N₂=6 may be considered. According to the existing technical specifications expressed in Table 1, this case may be interpreted as a case where Ng=1 is implied, so (N₁, N₂)=(3,3) may be supported. The proposed method may support a wider variety of cases. When Method 1 is applied, since N₂=5 for Nᵢ=1, one TB is mapped to five layers, and thus Nᵢ may be restricted as Nᵢ≥2.

Method 3: (N₁, N₂)=(2,4), (3,3), (4,2) may be supported. Alternatively, (N₁, N₂)=(2,4), (3,3) may be supported.

As an example, a case where N_{L}=N₁+N₂=7 and a case where N_{L}=N₁+N₂=8 may be considered. According to the existing technical specifications expressed in Table 1, these cases may be interpreted as a case where Ng=1 is implied, so (N₁, N₂)=(3,4), (4,3), (4,4) may be supported. In order to satisfy Nᵢ≤4, it may be preferable to utilize the technical specifications as they are.

When Ng is derived as 4, the terminal may be interpreted as having four transmission panels and valid combinations of (N₁, N₂, N₃, N₄) may be determined. Here, a case where the terminal uses two or more transmission panels at the same time is considered.

As an example, the proposed methods (i.e. Method 2 and Method 3) may be considered to be performed in a nested manner. Therefore, given (N₁, N₂), Nᵢ(i E {1, 2}) may be subdivided so that (N_{i,1}, N_{i,2}) satisfying N_{i,1}+N_{i,2}=Nᵢ can be derived. This may ultimately be interpreted as (N₁, N₂, N₃, N₄).

Method 4: A PUSCH layer combination may be configured by maintaining an overlapped structure or nested structure.

Method 5: N_{i,1}+N_{i,2}≤4 may be applied.

The terminal may transmit N_{L} layers using two, three, or four transmission panels. The number of DM-RS ports that the terminal can transmit simultaneously is eight, and some combinations of these support a higher level of coherence, while other combinations support a lower level of coherence or do not support coherence at all.

This may be related to a structure of a power amplifier (high PA (HPA)) of the terminal. As an example, when the terminal has two HPAs, one HPA may be associated with one transmission panel or two transmission panels. Transmission panels associated with the same HPA may be able to maintain a certain level of phase continuity/power coherence with each other. On the other hand, transmission panels associated with different HPAs may not maintain phase continuity/power coherence. Here, a fact that transmission panels maintain phase continuity/power coherence may mean that signals passing through PUSCH DM-RS ports of the transmission panels can be added to (combined with) each other as they are or after phase rotation.

As another example, the method in which (N₁, N₂, N₃, N₄) is determined when Ng is 4 may be a method of configuring subgroups for PUSCH DM-RS port groups of (N₁, N₂) when Ng is 2. That is, they may have a nested structure. As a result, the port groups as in Method 4 may be derived.

Method 6: The PUSCH DM-RS port combination when Ng is 4 may be a subset of the PUSCH DM-RS port combination when Ng is 2.

According to the method proposed above, (N₁, N₂)=(2,4), (1,4) may proposed, and in this case, codeword-layer mapping may be performed in the order of q (or in the opposite order). As an example, a mapping proposed in Table 2 may be applied.

Table 1 relates to code word-layer mapping and corresponds to Table 7.3.1.3-1 of 3GPP TS 38.211.

TABLE 1

| Number of | Number of | | |
|---|---|---|---|
| layers | codewords | Codeword-to-layer mapping i = 0, 1, . . . , M_{symb}^{layer} − 1 | |
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 3 | 1 | x⁽⁰⁾(i) = d⁽⁰⁾(3i) | M_{symb}^{layer} = M_{symb}⁽⁰⁾/3 |
| | | x⁽¹⁾(i) = d⁽⁰⁾(3i + 1) | |
| | | x⁽²⁾(i) = d⁽⁰⁾(3i + 2) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| 5 | 2 | x⁽⁰⁾(i) = d⁽⁰⁾(2i) | M_{symb}^{layer} = M_{symb}⁽⁰⁾/2 = M_{symb}⁽¹⁾/3 |
| | | x⁽¹⁾(i) = d⁽⁰⁾(2i + 1) | |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(3i) | M_{symb}^{layer} = M_{symb}⁽⁰⁾/3 = M_{symb}⁽¹⁾/3 |
| | | x⁽¹⁾(i) = d⁽⁰⁾(3i + 1) | |
| | | x⁽²⁾(i) = d⁽⁰⁾(3i + 2) | |
| | | x⁽³⁾(i) = d⁽¹⁾(3i) | |
| | | x⁽⁴⁾(i) = d⁽¹⁾(3i + 1) | |
| | | x⁽⁵⁾(i) = d⁽¹⁾(3i + 2) | |
| 7 | 2 | x⁽⁰⁾(i) = d⁽⁰⁾(3i) | M_{symb}^{layer} = M_{symb}⁽⁰⁾/3 = M_{symb}⁽¹⁾/4 |
| | | x⁽¹⁾(i) = d⁽⁰⁾(3i + 1) | |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = M_{symb}⁽⁰⁾/4 = M_{symb}⁽¹⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

Table 2 is an example of codeword-layer mapping.

TABLE 2

| Number of | Number of | Codeword-to-layer mapping |
|---|---|---|
| layers | codewords | i = 0, 1, . . . , M_{symb}^{layer} − 1 |
| 5 | 2 | x⁽⁰⁾(i) = d⁽⁰⁾(i) |
| | | x⁽¹⁾(i) = d⁽¹⁾(4i) |
| | | x⁽²⁾(i) = d⁽¹⁾(4i + 1) |
| | | x⁽³⁾(i) = d⁽¹⁾(4i + 2) |
| | | x⁽⁴⁾(i) = d⁽¹⁾(4i + 3) |
| | | M_{symb}^{layer} = M_{symb}⁽⁰⁾ = M_{symb}⁽¹⁾/4 |
| 6 | 2 | x⁽⁰⁾(i) = d⁽⁰⁾(2i) |
| | | x⁽¹⁾(i) = d⁽⁰⁾(2i + 1) |
| | | x⁽²⁾(i) = d⁽¹⁾(4i) |
| | | x⁽³⁾(i) = d⁽¹⁾(4i + 1) |
| | | x⁽⁴⁾(i) = d⁽¹⁾(4i + 2) |
| | | x⁽⁵⁾(i) = d⁽¹⁾(4i + 3) |
| | | M_{symb}^{layer} = M_{symb}⁽⁰⁾/2 = M_{symb}⁽¹⁾/4 |

The proposed methods may be used when ON/OFF on a TRP basis is dynamically supported for network energy saving in the mTRP scenario. The terminal may be indicated to perform transmission to two TRPs by one scheduling information, and the terminal may transmit a TB i to a TRP i. When the dynamic ON/OFF is performed on a TRP basis, retransmission of the TB may be performed for each TRP. Since network energy is consumed to deliver soft information (e.g. log-likelihood ratio (LLR) values) received from TRP i to TRP j through a backhaul network, retransmission may be preferably performed for each TRP.

In addition, in a scenario considering L1/L2 triggered mobility (LTM), measurement (e.g. L1 RSRP or L3 filtered RSRP measurement) on not only a source TRP but also target TRP(s) to support faster TRP switching may be performed. It may be preferable that the measured information can be quickly reported to the source TRP and/or target TRP. Meanwhile, a measurement report required for the source TRP to support LTM and a measurement report required for the target TRP to support LTM may be different. Accordingly, the measurement report for the source TRP and the measurement report for the target TRP may be expressed with different UCIs or TBs (i.e. codewords). Transmission to two TRPs may be indicated to the terminal by one scheduling information, and LTM may be performed when a TB i (i.e. measurement report) transmitted by the terminal is received at the TRP i.

Hereinafter, exemplary embodiments related to DM-RS port combinations will be described.

According to the existing technical specifications, a combination of PUSCH DM-RS ports for PUSCH transmission may be implicitly derived. When the terminal is indicated to perform codebook-based PUSCH transmission, a TPMI may indicate a precoding matrix (TPMI matrix). The terminal may identify layer-to-port mapping from the precoding matrix indicated by the TPMI.

Some layers may be combined and associated with one DM-RS port. Therefore, the number of layers and the number of DM-RS ports are not always the same. Two or more layers may correspond to one DM-RS port. For example, a layer 1 and a phase shifted version of a layer 2 may be combined to correspond to one DM-RS port. In this case, the layer 1 and layer 2 may maintain phase coherence and phase continuity.

In addition, combinations of the layer 1 and layer 2 may correspond to a DM-RS port 1 and a DM-RS port 2, respectively. For example, a combined value of the layer 1 and layer 2 may correspond to the DM-RS port 1, and a difference between the layer 1 and layer 2 may correspond to the DM-RS port 2. In this case, the DM-RS port 1 and DM-RS port 2 may maintain phase coherence and phase continuity and may be interpreted as belonging to one coherence group.

According to the existing technical specifications, in case of four DM-RS ports, DM-RS ports {0, 2} may form a coherence group, and DM-RS ports {1, 3} may form a coherence group. This may also be applied to a terminal with Ng of 2, and this method may be generalized to a case of 8 DM-RS ports.

Method 7: In case of 8 DM-RS ports, when Ng=2, DM-RS ports {0, 1, 2, 3} and {4, 5, 6, 7} may form coherence groups, respectively.

Method 8: In case of 8 DM-RS ports, when Ng=2, DM-RS ports {0, 2, 4, 6} and {1, 3, 5, 7} may form coherence groups, respectively.

Method 9: In case of 8 DM-RS ports, when Ng=4, DM-RS ports {0, 2}, {1, 3}, {4, 6}, and {5, 7} may form coherence groups, respectively.

Method 10: The coherence groups in case of Ng=4 may have a nested structure with respect to the coherence groups in case of Ng=2.

In Methods 7 to 10 described above, a structure of DFT weights is not considered. Therefore, port mapping that considers the structure of DFT weights and the coherence groups may be required.

According to the existing technical specifications, a TPMI for eight ports may follow Table 3 below, depending on the number of panels. In case of Ng=4, there may be no need to describe a TPMI based on Fourier transform, and Table 4 may be supported.

In order to express a TPMI, parameters N₁, N₂ for an antenna array and parameters O₁, O₂ for oversampling may be applied to represent weights that the terminal uses for transmission. A vector represented by v_{l,m} may mean weights of the l-th antenna on the first axis and the m-th antenna on the second axis. This may also be expressed as Equation 1 and Equation 2.

Table 3 shows valid (N_{g}, N₁, N₂) and (O₁, O₂) (excerpted from Table 5.2.2.2.1-1 and Table 5.2.2.2.2-2 of TS 38.214).

TABLE 3

| Number of CSI-RS | | |
|---|---|---|
| antenna ports | (N_{g}, N₁, N₂) | (O₁, O₂) |
| 8 | (1, 2, 2) | (4, 4) |
| | (1, 4, 1) | (4, 1) |
| | (2, 2, 1) | (4, 1) |

Table 4 shows valid (N_{g}, N₁, N₂) and (O₁, O₂).

TABLE 4

| Number of CSI-RS | | |
|---|---|---|
| antenna ports | (N_{g}, N₁, N₂) | (O₁, O₂) |
| 8 | (4, 1, 1) | (4, 1) |

Equation 1 relates to a weight of the m-th antenna on the second axis.

$${u}_{m} = ( 1 , exp ( j \frac{2 π m}{{O}_{2} {N}_{2}} ) , … exp ( j \frac{2 π m}{{O}_{2} {N}_{2}} \cdot ( {N}_{2} - 1 ) ) ) \qquad [ Equation 1 ]$$

Equation 2 relates to weights of the l-th antenna on the first axis and the m-th antenna on the second axis.

$${v}_{l , m} = {( {u}_{m} , exp ( j \frac{2 π l}{{O}_{1} {N}_{1}} ) \cdot {u}_{m} , … exp ( j \frac{2 π l}{{O}_{1} {N}_{1}} \cdot ( {N}_{1} - 1 ) ) \cdot {u}_{m} )}^{T} \qquad [ Equation 2 ]$$

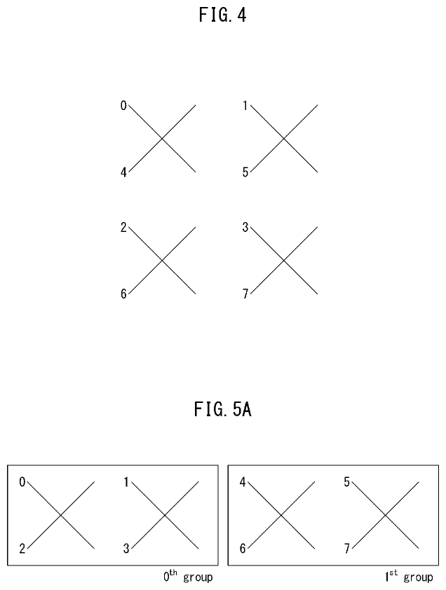

FIG. 3 is a conceptual diagram illustrating the order of ports according to an example of antenna array analysis, and FIG. 4 is a conceptual diagram illustrating the order of ports according to another example of antenna array analysis.

FIG. 3 illustrates the order of ports when the antenna array is interpreted as (N_{g}, N₁, N₂)=(1,4,1), and FIG. 4 illustrates the order of ports when the antenna array is interpreted as (N_{g}, N₁, N₂)=(1,2,2), when Equation 1 and Equation 2 are applied.

When a case of N_{g}>1 is additionally considered, coherence groups may be considered after polarization of the phased array. According to the proposed method, they may have a nested structure according to N_{g}.

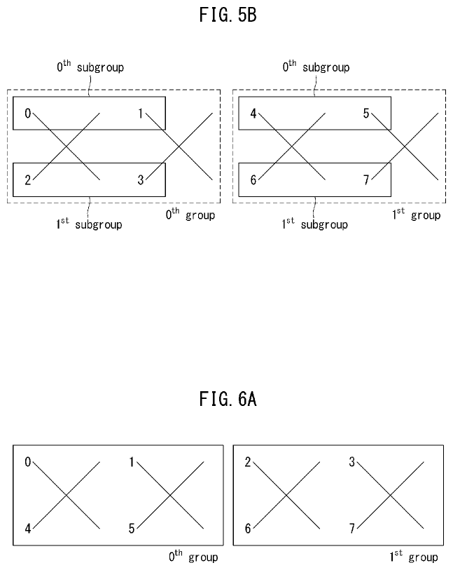

FIGS. 5A, 5B, 6A, 6B, 7A, 7B, 8A, 8B, 9A, 9B, 10A, 10B and 11 are conceptual diagrams illustrating examples of various port mappings considering an arrangement of antenna array and positions of antenna ports thereof.

In FIGS. 5A, 5B, 6A, 6B, 7A, 7B, 8A, 8B, 9A, 9B, 10A, 10B, and 11, port mappings considering not only N_{g}, N₁, N₂ but also the positions of antenna ports located in the respective coherence groups are illustrated.

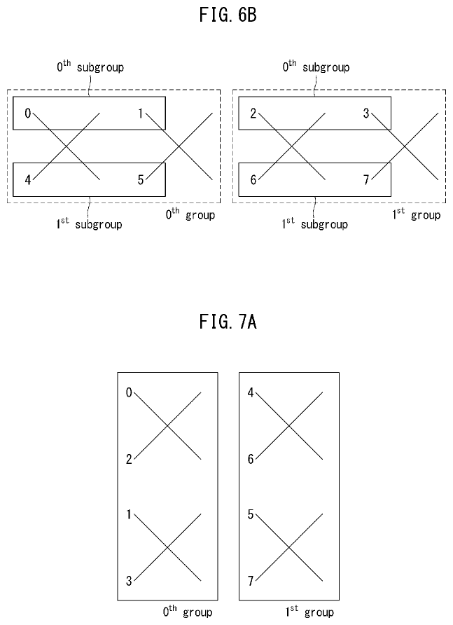

Coherence group and port mapping for a case of N_{g}=2 may be considered. FIGS. 5A and 6A may be considered as exemplary embodiments for a case where (N_{g}, N₁, N₂)=(2,1,2).

In FIG. 5A, separate port mapping may be performed for each coherence group. The coherence groups may be configured as DM-RS ports {0, 1, 2, 3} and {4, 5, 6, 7}, respectively.

In FIG. 6A, port mapping on an antenna array basis is performed first, regardless of the coherence groups, and then the coherence groups may be considered. The coherence groups may be configured as DM-RS ports {0, 1, 4, 5} and {2, 3, 6, 7}, respectively.

In case of N_{g}=4, while the coherence groups derived for the case of N_{g}=2 are maintained, port mappings additionally considering N_{g}=4 and satisfying nested structures may be derived. The port mapping for a case where (N_{g}, N₁, N₂)=(4,1,1) may be derived. As an example, in FIG. 5B where the case of N_{g}=4 is further considered based on FIG. 5A, the derived coherence subgroups may be DM-RS ports {0, 1}, {2, 3}, {4, 5}, and {6, 7}, respectively. As another example, in FIG. 6B where the case of N_{g}=4 is further considered based on FIG. 6A, the derived coherence subgroups may be DM-RS ports {0, 1}, {4, 5}, {2, 3}, and {6, 7}, respectively.

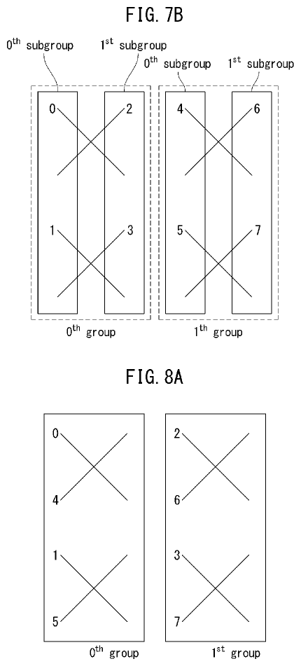

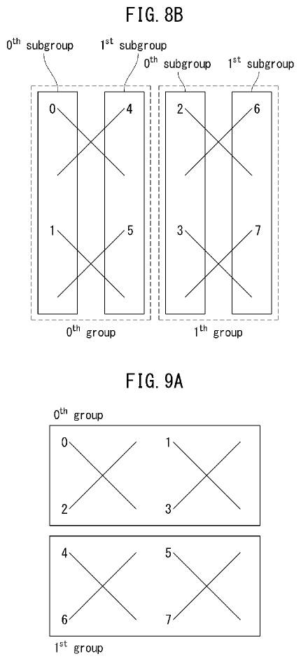

Given as a two-dimensional array, coherence groups and port mapping for the case of N_{g}=2 may be considered. FIGS. 7A and 8A may be considered as exemplary embodiments for a case where (N_{g}, N₁, N₂)=(2,2,2).

In FIG. 7A, separate port mapping may be performed for each coherence group. The coherence groups may be configured as DM-RS ports {0, 1, 2, 3} and {4, 5, 6, 7}, respectively. In FIG. 8A, port mapping may be performed on an antenna array basis. The coherence groups may be configured as DM-RS ports {0, 1, 4, 5} and {2, 3, 6, 7}, respectively.

Similarly, FIGS. 7B and 8B may be considered as exemplary embodiments for a case where (N_{g}, N₁, N₂)=(4,2,2).

In FIG. 7B, separate port mapping may be performed for each coherence group. The coherence subgroups may be configured as DM-RS ports {0, 1}, {2, 3}, {4, 5} and {6, 7}, respectively.

In FIG. 8B, port mapping may be performed on an antenna array basis. The coherence subgroups may be configured as DM-RS ports {0, 1}, {4, 5}, {2, 3} and {6, 7}, respectively.

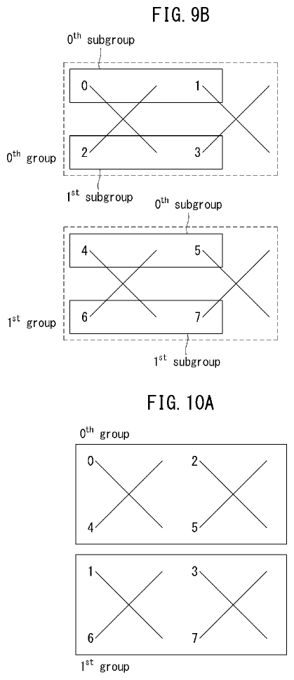

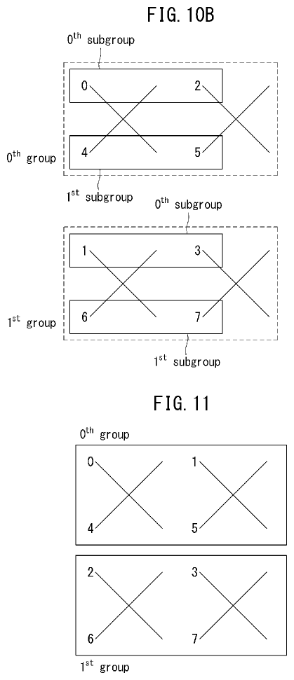

Other arrangements may be considered in the two-dimensional array. FIGS. 9A and 10A may be considered as exemplary embodiments for a case where (N_{g}, N₁, N₂)=(2,1,2).

In FIG. 9A, a separate port mapping may be performed for each coherence group. The coherence groups may be configured as DM-RS ports {0, 1, 2, 3} and {4, 5, 6, 7}, respectively.

In FIG. 10A, port mapping may be performed on an antenna array basis. The coherence groups may be configured as DM-RS ports {0, 2, 4, 5} and {1, 3, 6, 7}, respectively. However, if DFT weights are considered in the process of configuring coherence groups, other port mappings may be considered. In this case, the coherence groups may be configured as DM-RS ports {0, 2, 4, 5} and {1, 3, 6, 7}, respectively.

FIG. 11 illustrates an exemplary embodiment of coherence groups for a case where (N_{g}, N₁, N)=(2,1,2), which is based on FIG. 6A. FIGS. 6A and 11 may represent cases for antenna arrays configured differently in two dimensions even when the same N_{g} is applied. For example, the coherence groups are arranged horizontally in FIG. 6A, and the coherence groups are arranged vertically in FIG. 11.

In case of N_{g}=4, the coherence groups derived from N_{g}=2 may be divided into subgroups. As an example, coherence subgroups in FIG. 9B derived from FIG. 9A may be configured as DM-RS ports {0, 1}, {2, 3}, {4, 5}, and {6, 7}, respectively. As another example, coherence subgroups in FIG. 10B derived from FIG. 10A may be configured as DM-RS ports {0, 2}, {4, 5}, {1, 3}, and {6, 7}, respectively.

Method 11: When considering port mapping, port mapping may be firstly performed on an antenna array basis, and then coherence groups may be formed considering a structure of DFT weights.

Hereinafter, exemplary embodiments related to UCI multiplexing extension onto a PUSCH for multiple codewords will be described. According to the existing technical specifications, in limited cases, the terminal may transmit a PUSCH and PUCCH simultaneously. Here, the fact that the terminal transmits a PUSCH and PUCCH simultaneously may mean that the PUSCH and PUCCH are scheduled in the same symbol(s).

The terminal may transmit one or two TBs on a PUSCH. When only one TB is scheduled (i.e. when scheduling information for transmission of a PUSCH including one TB is received from the base station), uplink control information (UCI) may be multiplexed to the corresponding TB. When two TBs are scheduled (i.e. when scheduling information for transmission of a PUSCH including two TBs is received from the base station), TB(s) with which UCI is to be multiplexed may vary depending on the type of UCI. Specifically, a multiplexing procedure for hybrid automatic repeat request (HARQ)-hybrid automatic repeat request (ACK) and rank indicator (RI) may be different from a multiplexing procedure for channel quality indicator (CQI) and precoding matrix indicator (PMI) (and/or precoding type indicator (PTI)). The HARQ-ACK and RI may be multiplexed with two codewords according to two TBs, and may be time-division-multiplexed or frequency-division-multiplexed (TDMed/FDMed) with the codeword(s). The HARQ-ACK may puncture the codeword and the RI may be rate-matched with the codeword. On the other hand, the CQI/PMI/PTI may be multiplexed only with a codeword according to one TB. One TB with a higher target code rate or spectral efficiency or a lower target code rate or spectral efficiency compared to an MCS index applied to initial transmission therefor may be selected, and the CQI/PMI/PTI may be rate matched with a codeword according to the selected TB. When a TB is not transmitted, UCI (i.e. HARQ-ACK and/or CSI) may be jointly coded and transmitted on a PUSCH based on a rank 1.

The limited case where the terminal can transmit a PUSCH and PUCCH simultaneously may mean a case where frequency aggregation (inter-band CA) is performed in different frequency bands (inter-band) and priority indexes of the PUSCH and PUCCH are different from each other. That is, in the inter-band CA, if the PUSCH (or PUCCH) has a priority index 0 (i.e. eMBB) and the PUCCH (or PUSCH) has a priority index 1 (i.e. URLLC), the terminal may simultaneously transmit the PUSCH and PUCCH. In other cases, the terminal may multiplex the UCI on the PUSCH or transmit only one of the PUCCH and PUSCH in consideration of the priority indexes.

According to the existing technical specifications, when UCI is multiplexed on a PUSCH, the number of REs used by the UCI is determined using various parameters, and REs used by the TB may be determined as the remaining REs excluding the REs used by the UCI from REs available for the PUSCH. If the amount of UCI is 1 bit or 2 bits, spreading or simplex coding is performed on the UCI and it may be punctured on the PUSCH. Accordingly, coded data may be mapped to the PUSCH first, and then the coded UCI may be mapped to the PUSCH. If the amount of UCI is 3 bits or more, Reed-Muller coding or polar coding is performed on the UCI, and the coded UCI may be rate-matched to the PUSCH.

Hereinafter, a method applied for each specific UCI type will be described in more detail. However, the following description is for a method of UCI multiplexing when one TB is transmitted.

In case of HARQ-ACK, Equation 3 may be applied. O_{AC}K denotes the length of HARQ-ACKs, L_{ACK} denotes the length of CRC, M_{sc}^{UCI} denotes the number of subcarriers of the l-th symbol, Kᵣ denotes the size of the r-th code block, N_{symb,all}^{PUSCH} denotes the number of symbols of the PUSCH, C_{UL-SCH} denotes the number of code blocks that the TB has, and l₀ denotes the index of the first symbol not including DM-RS (or the first index after the DM-RS symbol). Here, β_{offset}^{PUSCH} (or beta offset) roughly represents a ratio of an effective code rate of the HARQ-ACK and a code rate of the PUSCH. Various values therefor are indicated to the terminal through RRC signaling and an index indicating one of the various values may be indicated to the terminal through UL-DCI. α (or alpha scaling or scaling) may act as an upper limit to prevent the HARQ-ACK from taking up too many REs. One value therefor may be indicated to the terminal through RRC signaling. R represents a reference code rate when a UL-SCH is not mapped and only the UCI is transmitted and may be obtained from scheduling DCI

Since similar equations (Equation 4, Equation 5, Equation 6, Equation 7, Equation 8) may be applied not only to the HARQ-ACK but also to other UCI types (i.e. SR, L1-RSRP, CSI), the methods described below may be easily extended and applied.

Equation 3 relates to the number of REs when HARQ-ACK is mapped to the PUSCH to which a UL-SCH is mapped.

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{{l}_{0} = 0}^{{N}_{symb , all}^{PUSCH} - 1} {M}_{sc}^{UCI} ( l ) ⌉ \} \qquad [ Equation 3 ]$$

Equation 4 relates to the number of REs when HARQ-ACK is mapped to the PUSCH to which a UL-SCH is not mapped.

$${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ , \\ ⌈ α \cdot {\sum }_{{l}_{0} = 0}^{{N}_{symb , all}^{PUSCH} - 1} {M}_{sc}^{UCI} ( l ) ⌉ \} \qquad [ Equation 4 ]$$

Equation 5 relates to the number of REs when a CSI part 1 is mapped to the PUSCH to which a UL-SCH is mapped.

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{c}^{UCI} ( l )}{{\sum }_{r = 0}^{{C}_{UL - SCH} - 1} {K}_{r}} ⌉ , \\ ⌈ α \cdot {\sum }_{{l}_{0} = 0}^{{N}_{symb , all}^{PUSCH} - 1} {M}_{sc}^{UCI} ( l ) ⌉ - {Q}_{ACK}^{′} \} \qquad [ Equation 5 ]$$

Equation 6 relates to the number of REs when a CSI part 1 is mapped to the PUSCH to which a UL-SCH is not mapped.

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , \\ {\sum }_{{l}_{0} = 0}^{{N}_{symb , all}^{PUSCH} - 1} {M}_{sc}^{UCI} ( l ) - {Q}_{ACK}^{′} if CSI part 2 is on PUSCH , \\ or {\sum }_{{l}_{0} = 0}^{{N}_{symb , all}^{PUSCH} - 1} {M}_{sc}^{UCI} ( l ) - {Q}_{ACK}^{′} if \\ CSI part 2 is not on PUSCH \qquad [ Equation 6 ]$$

Equation 7 relates to the number of REs when a CSI part 2 is mapped to the PUSCH to which a UL-SCH is mapped.

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{{l}_{0} = 0}^{{N}_{symb , all}^{PUSCH} - 1} {M}_{sc}^{UCI} ( l ) ⌉ - {Q}_{ACK}^{′} - {Q}_{CSI - 1}^{′} \} \qquad [ Equation 7 ]$$

Equation 8 relates to the number of REs when a CSI part 2 is mapped to the PUSCH to which a UL-SCH is not mapped.

$${Q}_{CSI - 2}^{′} = {\sum }_{{l}_{0} = 0}^{{N}_{symb , all}^{PUSCH} - 1} {M}_{sc}^{UCI} ( l ) - {Q}_{ACK}^{′} - {Q}_{CSI - 1}^{′} \qquad [ Equation 8 ]$$

When UCI is multiplexed on a PUSCH, not only a beta offset but also alpha scaling is applied to determine the number of REs that the coded UCI can occupy. The alpha scaling is used to determine an upper limit on the number of REs. For example, when the beta offset is indicated so that only very few REs are allocated to the TB belonging to the PUSCH, or when the REs of the PUSCH are so small that the indicated beta offset cannot be applied, the upper limit of alpha scaling may be used.

When UCI is multiplexed on a PUSCH including two TBs, the above method and equations need to be modified. For convenience of description, the two TBs may be expressed as a TB 0 (q=0) and TB 1 (q=1). In this case, the PUSCH may be scheduled to be transmitted through five or more data layers (or PUSCH layers).

Hereinafter, a puncturing/rate matching method for the case where UCI is multiplexed and a method for delivering parameters required therefor will be described.

In the proposed method, PUSCH layer(s) where the UCI is multiplexed may be selected as either PUSCH layer(s) of the TB 0 or PUSCH layer(s) of the TB 1. Specifically, one TB may be determined according to Method 12 and/or Method 13. The UCI may be multiplexed with the determined TB when puncturing/rate matching is performed for the TB. Additionally, only the selected TB may be multiplexed with the UCI in a step of performing RE mapping.

Method 12: One TB may be determined according to the technical specifications (e.g. q=0 or q=1 is always selected).

There is no need for the terminal to perform calculations to select a TB multiplexed with the UCI, and the technical specifications may define that puncturing/rate matching for UCI multiplexing is always performed only on the TB 0 (or TB 1). Method 12 has the advantage of being simple to implement, but has the disadvantage that the effective code rate of the TB 0 (or TB 1) always increases. To solve this problem, when indicating scheduling information to the terminal, the base station may indicate a lower nominal code rate as an MCS for the TB 0 (or TB 1). For a more flexible selection, Method 13 below may be applied.

Method 13: One TB may be selected through scheduling information.

Since puncturing and/or rate matching is performed for the TB multiplexed with the UCI, the effective code rate may be increased. Here, the effective code rate or effective spectral efficiency may be determined by the number of REs (E bits) to which the coded data (or coded UL-SCH) is actually mapped after the rate matching. Accordingly, a TB (q=0, 1) with a higher nominal code rate or higher spectral efficiency may be selected from the scheduling information (e.g. MCS) of the PUSCH. This is because an error rate achievable for the UCI is reduced because the selected TB experiences a radio channel with better quality.

For the selected q, Q′ may be derived using the existing equations. Here, Q′ may mean Q_{ACK}′, Q_{CSI-1}′, and Q_{CSI-2}′, respectively.

In the step of performing RE mapping for the coded UCI and coded data (or coded UL-SCH), the maximum length of coded data is determined in units of N_{L}·Qₘ, but since the coded UCI is multiplexed with one TB q (q=0 or q=1), the maximum length of the coded UCI may be preferably determined based on the number of layers through which the TB q is transmitted.

In another proposed method, the UCI may be multiplexed with all TBs. This may be described based on Method 14 and more specific Method 15 below.

Method 14: UCI may be commonly multiplexed to all TBs.

In Method 14, a unit of mapping the coded bits to one RE in order for the terminal to perform rate matching of the UCI may be expressed as N_{L}·Qₘ. When Method 14 is applied, N_{L} may be interpreted as the number of all layers to which the TB 0 and TB 1 are mapped. This is different from Method 12 and Method 13, where N_{L} is interpreted as the number of layers to which the corresponding TB q is mapped.

Method 14 is convenient to implement because the terminal performs puncturing/rate matching in units of N_{L}·Qₘ in the step of performing RE mapping for the coded UCI and coded data (or coded UL-SCH). In case of a PUSCH to which frequency hopping is applied, the coded UCI with a total length (G bits) may be divided into a first hop of

$${N}_{L} \cdot {Q}_{m} \cdot ⌊ \frac{G}{2 \cdot {N}_{L} \cdot {Q}_{m}} ⌋$$

bits and a second hop of

$${N}_{L} \cdot {Q}_{m} \cdot ⌈ \frac{G}{2 \cdot {N}_{L} \cdot {Q}_{m}} ⌉$$

bits, and they may be modulated, precoded, and mapped to REs. In case of a PUSCH to which frequency hopping is not applied, the total length of the coded UCI may be given as G bits. This may be obtained using appropriate parameters for each UCI type.

Since the number of code blocks for deriving the effective code rate of the UCI changes, the method of deriving Q′ also needs to be modified.

Method 15: To derive Q′ of the UCI, the number of code blocks of each TB may be summed. That is, for q=0, K₀+K₁+ . . . +K_{C}_{_{UL-SCH}}₋₁ may be calculated, and for q=1, K₀+K₁+ . . . +K_{C}_{_{UL-SCH}}₋₁ may calculated. Then, they may be summed.

Since one TB is scheduled according to the existing technical specifications, β_{offset}^{PUSCH} therefor means a relative ratio. When Method 15 is applied, values of β_{offset}^{PUSCH} configured by the base station through RRC signaling may be reused. Since β_{offset}^{PUSCH} applied to two TBs is selected from values indicated considering one TB, the value indicated to the terminal may not be the most appropriate value for lowering the error rate of the UCI.

Method 16: For each UCI type, Q′ may be calculated for all TBs (q=0, q=1) by using the values of β_{offset}^{PUSCH} obtained from scheduling information of a PUSCH, and a larger value among then may be considered as Q′.

As an example, considering Equation 3 again when the UCI type is HARQ-ACK/LRR/CG-UCI, since the number O_{ACK}+L_{ACK} of information bits is the same, and the resource of the PUSCH is the same, Σₗ₌₀^{N}^{_{symb,all}}^{^{PUSCH}}₋₁M_{sc}^{UCI}(l) may the same and α·Σₗ₌₀^{N}^{_{symb,all}}^{^{PUSCH}}₋₁M_{sc}^{UCI}(l) acting as an upper limit may also be the same.

Therefore, values of Q′ may be compared using Equation 9 below. When the PUSCH is generated only with UCI without a UL-SCH, comparison of values of Q′ for the TB may be unnecessary. In this case, Equation 10 below may be used instead. Equation 9 or Equation 10 may be applied to obtain Q′ for other UCI types in the same manner.

In the step of multiplexing the coded data and the coded UCI, since a larger Q′ is applied to each UCI type and applied to all layer(s) or some layer(s), so the effective code rate experienced by the TB may increase.

Equation 9 relates to a metric for comparing the sizes of Q′ of a UCI type when a UL-SCH exists.

$$\frac{{β}_{offset}^{PUSCH}}{{\sum }_{r = 0}^{{C}_{UL - SCH} - 1} {K}_{r}} \qquad [ Equation 9 ]$$

Equation 10 relates to a metric for comparing the sizes of Q′ of a UCI type when a UL-SCH is absent.

$$\frac{{β}_{offset}^{PUSCH}}{R \cdot {Q}_{m}} \qquad [ Equation 10 ]$$

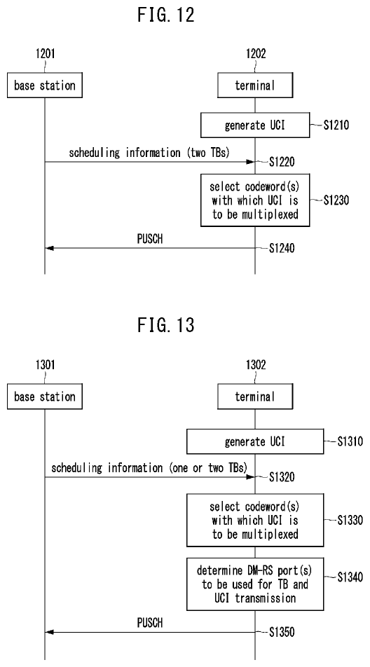

FIG. 12 is a flow chart illustrating a method of transmitting a PUSCH including two codewords according to an exemplary embodiment of the present disclosure.

Referring to FIG. 12, a terminal 1202 may perform a step S120 of generating UCI; a step S1220 of receiving from a base station 1201 scheduling information for transmission of a PUSCH including a first TB and a second TB; a step S1230 of selecting codeword(s) with which the UCI is to be multiplexed from among a codeword according to the first TB and a codeword according to the second TB; and a step S1240 of transmitting the PUSCH in which the selected codeword(s) and the UCI are multiplexed.

In step S1240, the PUSCH may be transmitted using five or more layers. This may mean that the scheduling information allocates five or more PUSCH DM-RS ports to the PUSCH.

The selected codeword(s) may be one predefined codeword. That is, the codeword(s) to be selected in the above situation may be predefined by the technical specifications. That is, the selected codeword(s) may be predefined by Method 12 described above.

Alternatively, the selected codeword(s) may be selected based on the scheduling information. That is, the selected codeword(s) may be selected based on the scheduling information by Method 13 described above.

Here, the one codeword may be selected by deriving a spectral efficiency of the first TB and a spectral efficiency of the second TB from the scheduling information; and selecting a codeword associated with a TB with a higher spectral efficiency among the spectral efficiency of the first TB and the spectral efficiency of the second TB as the one codeword.

When the spectral efficiency of the first TB and the spectral efficiency of the second TB are the same, one TB defined in the technical specification (e.g. a TB with q=0) may be selected. When the first or second TB is retransmitted, the spectral efficiency may be determined as a nominal code rate used when the corresponding TB is initially transmitted.

Meanwhile, when the first TB or the second TB is initially transmitted, the spectral efficiency of the first TB or the second TB may be determined based on the scheduling information for transmission of the PUSCH, and when the first TB or the second TB is retransmitted, the spectral efficiency of the first TB or the second TB may be determined based on scheduling information for an initial transmission PUSCH for the first TB or the second TB.

For convenience of description, the exemplary embodiment of FIG. 12 includes descriptions of only some of the various methods (Methods 12 to 16) described above, but other methods may also be easily applied.

Hereinafter, exemplary embodiments related to UCI multiplexing extension onto a PUSCH for single or multiple codewords will be described. According to the existing technical specifications, when the same symbol(s) are assigned to a PUCCH to be transmitted including UCI and a PUSCH to be transmitted including at least one TB, the UCI and the at least one TB may be transmitted on a single PUSCH as being multiplexed. Here, since the number of DM-RS ports that can be scheduled is 4 when the at least one TB is one TB, the TB should also always be transmitted on ports through which the UCI is transmitted.

A case may be considered where at least one TB (TB 0 or TBs 0 and 1) is to be transmitted, UCI is also to be transmitted, and more than five DM-RS ports are available in the radio channel. As an example, since the UCI and a UL-SCH (i.e. TB) should be multiplexed, the UCI may always be transmitted using only DM-RS port(s) through which the UL-SCH is transmitted. That is, PUSCH DM-RS port(s) to be used for transmission of the TB are defined as first PUSCH DM-RS port(s), and PUSCH DM-RS port(s) to be used for transmission of the UCI are defined as second PUSCH DM-RS port (s), the second PUSCH DM-RS port(s) should be a subset of the first PUSCH DM-RS port(s).

Method 17: When UCI and at least one TB are transmitted on a PUSCH, the UCI and at least one TB may be transmitted using all DM-RS ports indicated by scheduling information.

When at least one TB is one TB (e.g. TB 0), layer-port mapping may be performed and four or fewer DM-RS ports may be used. However, when Method 17 is used, the UCI should be able to be transmitted through all ports. This may mean that the method for calculating Q′ for rate matching of the UCI needs to be modified.

As an example, if n DM-RS ports are obtained from scheduling information, the TB may be mapped only to four DM-RS ports. The coded UCI may be transmitted alone through (n−4) DM-RS ports, and may be multiplexed with the TB in the four DM-RS ports to which the TB is mapped.

Here, the number of REs to which the coded UCI can be mapped may be sufficiently secured considering a code rate (i.e. target code rate or nominal code rate) indicated for each type of UCI (UCI type). An effective code rate of the UCI may be derived by applying a beta offset to a code rate of the TB.

Method 18: When calculating the rate matching of the UCI, the UCI may be assumed to be multiplexed with one (e.g. TB 0) of the at least one TB, and only the coded UCI may be transmitted through some DM-RS ports.

That is, when PUSCH DM-RS port(s) to be used for transmission of the TB are defined as the first PUSCH DM-RS port(s), and PUSCH DM-RS port(s) to be used for transmission of the UCI are defined as the second PUSCH DM-RS port(s), there may be PUSCH DM-RS port(s) that belong to the second PUSCH DM-RS port(s) but do not belong to the first PUSCH DM-RS port(s).

According to the proposed method, the DM-RS port(s) through which the UCI is transmitted alone and the DM-RS port(s) through which the TB is transmitted may experience interference between MIMO layers. In addition, if the type of UCI is HARQ-ACK, the terminal may not receive scheduling DCI for the PDSCH, resulting in a discontinuous transmission (DTX) where the terminal does not know the existence of HARQ-ACK. There may be one TB to be transmitted using the PUSCH, and five or more DM-RS ports may be allocated to the PUSCH. If a DTX occurs, the terminal may map the TB to PUSCH layers by using all DM-RS ports or some DM-RS port(s) (i.e. the first DM-RS port(s)). However, according to the proposed method, the HARQ-ACK may need to be mapped only to some DM-RS port(s) (i.e. the second DM-RS port(s)).

As an example, when only one TB is to be transmitted, no more than four DM-RS ports may be allocated. When a CSI trigger is indicated, a CSI report may always be multiplexed with the TB.

Method 19: If only a TB 0 (or TB 1) is scheduled to be transmitted according to scheduling information, the maximum number of DM-RS ports that can be allocated may be 4 or less.

In the proposed method, the terminal may not be scheduled to transmit PUSCH layers to which only UCI is mapped. If a channel state can support a higher rank, a method to further utilize this may be needed.

Method 20: From scheduling information, information on mapping of the TB 0 may be derived from information allocating the TB 0, and information on mapping of the UCI may be derived from information allocating the TB 1.

In this case, the coded UCI and the TB may be spatially multiplexed so that only the UCI is transmitted through one layer and only the TB is transmitted through other layer(s). Although interference between the PUSCH layers may occur at the base station, there may be little degradation in BLER performance because the effective code rate of the UCI may be very small.

As an example, rate matching for the UCI may be performed using an MCS index 1 indicated in an MCS field 1 to be applied to the TB 1. In the step of deriving Q′, a target code rate according to the MCS index 1 may be used as a value of R.

However, in order to obtain the maximum transmission amount that can be obtained from the radio channel, it may be preferable that the UCI is transmitted through all scheduled ports. In this case, since one TB is mapped only to a maximum of four DM-RS ports, a method of mapping the coded UCI may be required.

According to a proposed method, it may be preferable for the terminal to be able to use one MCS index. When a UL-SCH indicator indicates ‘absence’ (i.e. when a UL-SCH does not exist in the PUSCH), the terminal may obtain an MCS index from scheduling information for at least one TB, and may obtain an MCS index from scheduling information for at most one TB. For example, it may be assumed that an MCS index 0 for the TB 0 is 0, or it may be indicated by the terminal to obtain an MCS index q from a TB q through a separate configuration.

In a proposed method, q may be indicated to the terminal and an MCS index q may be used to derive a code rate of the UCI. In this case, an MCS index q′ may be 26.

In another proposed method, at least one MCS index may be indicated to the terminal. When two MCS indexes are indicated, a specific MCS index may be applied by the technical specifications. For example, an MCS index for q=0 may be always applied.

When performing rate matching for the TB 0, the terminal may apply R0 obtained from the MCS field 0. Methods for providing a target code rate (or nominal code rate) when performing rate matching for the UCI may refer to Equations 3 to 10 above.

Method 21: If information on a UL-SCH indicator is explicitly given, Q′ for UCI may be derived by applying RI obtained from the MCS field 1.

Both the MCS field 0 and MCS field 1 may be used.

If information on a UL-SCH indicator is implicitly derived, rate matching for the UCI may be performed using R0 obtained from the MCS field 0 and the beta offset. In this case, RI obtained from the MCS index 1 may be ignored.

Method 22: When only UCI is transmitted on a PUSCH, it may be transmitted using all DM-RS ports indicated by scheduling information.

FIG. 13 is a flow chart illustrating a method of transmitting a PUSCH including one codeword or multiple codewords according to an exemplary embodiment of the present disclosure.

Referring to FIG. 13, a terminal 1302 may perform a step S1310 of generating UCI; a step S1320 of receiving from a base station 1301 scheduling information for transmission of a PUSCH including at least one TB; a step S1330 of selecting codeword(s) with which the UCI is to be multiplexed from among codeword(s) according to the at least one TB; a step S1340 of determining first PUSCH DM-RS port(s) to be used for transmission of the at least one TB and second PUSCH DM-RS port(s) to be used for transmission of the UCI; and a step S1350 of transmitting the PUSCH in which the selected codeword(s) and the UCI are multiplexed using the determined first PUSCH DM-RS port(s) and second PUSCH DM-RS port(s).

In the step S1350, the PUSCH may be transmitted using five or more layers. This may mean that the scheduling information allocates five or more PUSCH DM-RS ports to the PUSCH. Meanwhile, the PUSCH may be transmitted using five or more layers and may correspond to one SRS resource. The SRS resource may be configured with ports {0, 1, . . . , 7}.

Meanwhile, when the UCI is an HARQ-ACK, HARQ codebook for an SPS PDSCH, periodic CSI report, semi-persistent CSI report, or aperiodic CSI report, five or more DM-RS ports may be allocated to the PUSCH.

The second PUSCH DM-RS port(s) may be a subset of the first PUSCH DM-RS port(s).

Alternatively, the first PUSCH DM-RS port(s) and the second PUSCH DM-RS port(s) may be all PUSCH DM-RS ports indicated by the scheduling information. This may correspond to Method 17 described above.

Alternatively, there may be PUSCH DM-RS port(s) that belong to the second PUSCH DM-RS port(s) and do not belong to the first PUSCH DM-RS port(s). This may correspond to Method 18 described above.

For convenience of description, the exemplary embodiment of FIG. 13 includes descriptions on only some of the various methods (Methods 17 to 22) described above, but other methods may also be easily applied.

Meanwhile, the at least one TB may include a first TB and a second TB, the first PUSCH DM-RS port(s) may be divided into a first subset including first-first DM-RS port(s) to which a codeword corresponding to the first TB is mapped and a second subset including first-second DM-RS port(s) to which a codeword corresponding to the second TB is mapped, an intersection of the first subset and the second subset may be an empty set, and the second PUSCH DM-RS port(s) may be the first-first PUSCH DM-RS port(s) or the second-second PUSCH DM-RS port(s).

Meanwhile, coherence may be maintained in all or a subset of the first PUSCH DM-RS port(s).

Alternatively, coherence may be maintained in all or a subset of {0, 1, 4, 5} among the first PUSCH DM-RS port(s), and coherence may be maintained in all or a subset of {2, 3, 6, 7} among the first PUSCH DM-RS port(s).

Alternatively, coherence may be maintained in all or a subset of {0, 1} among the first PUSCH DM-RS port(s), coherence may be maintained in all or a subset of {2, 3} among the first PUSCH DM-RS port(s), coherence may be maintained in all or a subset of {4, 5} among the first PUSCH DM-RS port(s), and coherence may be maintained in all or a subset of {6, 7} among the first PUSCH DM-RS port(s).

When the at least one TB is one TB, the first PUSCH DM-RS port(s) and the second PUSCH DM-RS port(s) may be all PUSCH DM-RS ports indicated by the scheduling information.

A PUSCH including only UCI may be scheduled without a UL-SCH being mapped.

According to the existing technical specifications, when scheduling information in which a CSI trigger is indicated and a UL-SCH indicator indicates a specific value (e.g. 0) is received, the terminal may generate a PUSCH including only UCI. An MCS index is indicated in an MCS field of the scheduling information. A target code rate R may be derived from the MCS index, which may be used to calculate an effective code rate applied to the UCI.

According to the existing technical specifications, since the number of TBs for a PUSCH is 1, presence or absence of a TB i may be expressed with only one bit in the scheduling information. For a case where two TBs exist, an extended Method 23 or Method 24 may be considered.

Method 23: The UL-SCH indicator is given as 1 bit, and may express whether a TB 1 and TB 0 are allocated.

Method 24: The UL-SCH indicator is extended to 2 bits, so that the two bits express presence or absence of the TB 1 and TB 0, respectively.

Depending on how the terminal multiplexes UCI and TB(s), there may be no need to distinguish between the TB 1 and TB 0. In this case, as in Method 23, the presence and absence of TB(s) may be expressed with one bit. On the other hand, if one of the two TBs, with which the UCI is multiplexed, is to be controlled independently, presence or absence of each of the TB 1 and TB 0 may be important. In this cases, two bits may be needed, as in Method 24.

When Method 23 is used, enabling or disabling of one or more TBs may be indicated by specific values of MCS index and/or RV. For example, if an MCS index for a certain TB is indicated as 26 and an RV therefor is indicated as 1, this may be interpreted as disabling of the corresponding TB. Therefore, a UL-SCH may be transmitted through another TB.

When two codewords (TBs) are scheduled, code rates for the two codewords may be indicated from the MCS index 0 and MCS index 1, respectively, and since UCI is encoded in one TB, only one code rate should be indicated. However, in the step of performing rate matching for the UCI, the code rate of the UCI may be expressed as a relative value to the code rate of the TB. Since DM-RS port(s) mapped to each TB are distinct, the rate matching for the UCI may be derived differently for each DM-RS port.

For example, the TB 0 may be mapped to DM-RS ports 0, 1, and 2 at a code rate of R0, and the TB 1 may be mapped to DM-RS ports 3, 4, and 5 at a code rate of R1. When the UCI can be mapped to all DM-RS ports, Q0 REs may be allocated to the DM-RS ports 0, 1, and 2, and Q1 REs may be allocated to the DM-RS ports 3, 4, and 5. Because Q0 and Q1 may be different, spatial division multiplexing (SDM) may be considered in the mapping of the UCI.

Method 25: Rate matching for UCI may be derived differently for each DM-RS port.

SDM may not be considered in the mapping of the UCI, and the same TB (or coded UCI) may be modulated and mapped to all DM-RS ports. In this case, when at least one TB is scheduled, one or more code rates are indicated to the terminal, so a case where a maximum of one TB is scheduled may be considered.

In a proposed method, when a TB is not scheduled or when one TB is scheduled, UCI may be mapped to all DM-RS ports. The case where a TB is not scheduled may correspond to a case where a UL-SCH indicator in scheduling DCI may indicate absence of a TB, or a case where the MAC layer does not deliver a TB to the PHY layer.

A TB may be mapped to one or more layers, and multiple (five or more) DM-RS ports may be allocated to the TB according to scheduling information. Here, if the TB is mapped to one layer, a PUSCH may be transmitted using a DFT-s-OFDM modulation scheme, or if the TB is mapped to one or more layers, a PUSCH may be transmitted using a CP-OFDM modulation scheme. In this case, R0 (or RI) obtained from the MCS index 0 (or MCS index 1) may be applied to five or more DM-RS ports.

Method 26: When only UCI is transmitted on a PUSCH, it may be mapped to all DM-RS ports.

When two TBs are scheduled, the terminal may multiplex UCI with one TB (TB q, q=0 or 1) and not multiplex the UCI with the other TB (TB q′, q+q′=1). The UCI may be mapped only to layer(s) and/or DM-RS port(s) to which the TB q is mapped.

For example, since the TB q can only be mapped to four or fewer DM-RS ports, the UCI may need to use only four or fewer DM-RS ports.

Method 27: When only UCI is transmitted on a PUSCH, only four or fewer DM-RS ports are utilized.

In a proposed method, the number of DM-RS ports to which the UCI is mapped may be limited depending on a waveform (i.e. DFT-s-OFDM or CP-OFDM) used by the PUSCH. The limited number of DM-RS ports may be the number of DM-RS ports to which the TB q multiplexed with the UCI is mapped.

Method 28: In a PUSCH based on DFT-s-OFDM, UCI may be transmitted using all DM-RS ports, and in a PUSCH based on CP-OFDM, UCI may be transmitted using only specific DM-RS ports.

In another proposed method, regardless of a waveform used by the PUSCH, all DM-RS ports may be used when one layer is used, and only specific DM-RS ports may be used when two or more layers are used.

Method 29: When there is one data layer, all DM-RS ports may be used, and if two or more layers are used, only specific DM-RS ports may be used.

The UCI type may be classified into at least SR/LRR/HARQ-ACK/CG-UCI, CSI part 1, and CSI part 2. In the existing technical specifications, joint coding of UCIs may be performed according to UCI types, or separate coding may be performed for each UCI type.

For example, SR/LRR, HARQ-ACK, and CG-UCI may be concatenated together and undergo an encoding procedure as one information block. For example, SR/LRR, HARQ-ACK, CG-UCI, and CSI part 1 may be concatenated together and undergo an encoding procedure as one information block.

When generating a PUSCH to which two TBs are mapped, TB(s) with which UCI can be multiplexed may vary for each UCI type. This may mean that Method 12, Method 13, or Method 15 is applied separately for each UCI type.

Method 30: A TB with which a CSI part 2 is multiplexed and a TB with which other UCI type(s) (e.g. SR/LRR, HARQ-ACK, CG-UCI, and/or CSI part 1) are multiplexed may be the same or different.

For example, other UCI type(s) may be multiplexed to any TB, but a TB with which a CSI part 2 is multiplexed may be one TB. Method 12 or Method 13 may be applied to determine the TB with which the CSI part 2 is multiplexed.

Method 31: A TB with which a CSI part 2 is multiplexed and a TB with which other UCI type(s) (e.g. SR/LRR, HARQ-ACK, CG-UCI, and/or CSI part 1) are multiplexed may be determined to be always different according to the technical specifications.

For example, other UCI type(s) may be multiplexed to the TB 0 (q=0), and the CSI part 2 may be multiplexed on the TB 1 (q=1). Alternatively, other UCI type(s) may be multiplexed to the TB 1 (q=1), and the CSI part 2 may be multiplexed to the TB 0 (q=0). Q′ may be derived by referring to an appropriate value expressed by SPCH for each UCI type.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
generating uplink control information (UCI);
receiving scheduling information for transmission of a physical uplink shared channel (PUSCH) including a first transport block (TB) and a second TB;
selecting codeword(s) with which the UCI is to be multiplexed from among a codeword according to the first TB and a codeword according to the second TB; and
transmitting the PUSCH in which the selected codeword(s) and the UCI are multiplexed.

2. The method according to claim 1, wherein the PUSCH is transmitted using five or more layers.

3. The method according to claim 1, wherein the selected codeword(s) is one codeword selected by the scheduling information.

4. The method according to claim 3, wherein the one codeword is selected by:
deriving a spectral efficiency of the first TB and a spectral efficiency of the second TB from the scheduling information; and
selected a codeword associated with a TB with a higher spectral efficiency among the spectral efficiency of the first TB and the spectral efficiency of the second TB as the one codeword.

5. The method according to claim 4, wherein when the spectral efficiency of the first TB and the spectral efficiency of the second TB are same, a codeword associated with the first TB is selected as the one codeword.

6. The method according to claim 4, wherein when the first TB or the second TB is initially transmitted, the spectral efficiency of the first TB or the second TB is determined based on the scheduling information for transmission of the PUSCH, and when the first TB or the second TB is retransmitted, the spectral efficiency of the first TB or the second TB is determined based on scheduling information for a PUSCH initially transmitted for the first TB or the second TB.

7. A method of a terminal, comprising:
generating uplink control information (UCI);
receiving scheduling information for transmission of a physical uplink shared channel (PUSCH) including at least one transport block (TB);
selecting codeword(s) with which the UCI is to be multiplexed from among codeword(s) according to the at least one TB;
determining first PUSCH demodulation-reference signal (DM-RS) port(s) to be used for transmission of the at least one TB and second PUSCH DM-RS port(s) to be used for transmission of the UCI; and
transmitting the PUSCH in which the selected codeword(s) and the UCI are multiplexed by using the determined first PUSCH DM-RS port(s) and second PUSCH DM-RS port(s).

8. The claim according to claim 7, wherein the PUSCH is transmitted using five or more layers and corresponds to one sounding reference signal (SRS) resource having eight ports, and each port of the PUSCH is preprocessed identically to each corresponding port in the SRS resource.

9. The claim according to claim 7, wherein the at least one TB includes a first TB and a second TB, the first PUSCH DM-RS port(s) is divided into a first subset including first-first DM-RS port(s) to which the codeword corresponding to the first TB is mapped and a second subset including first-second DM-RS port(s) to which the codeword corresponding to the second TB is mapped, an intersection of the first subset and the second subset is an empty set, and the second PUSCH DM-RS port(s) are the first-first PUSCH DM-RS port(s) or the first-second PUSCH DM-RS port(s).

10. The claim according to claim 9, wherein coherence is maintained in all or a subset of the first PUSCH DM-RS port(s).

11. The claim according to claim 9, wherein coherence is maintained in all or a subset of {0, 1, 4, 5} among the first PUSCH DM-RS port(s), and coherence is maintained in all or a subset of {2, 3, 6, 7} among the first PUSCH DM-RS port(s).

12. The claim according to claim 9, wherein coherence is maintained in all or a subset of {0, 1} among the first PUSCH DM-RS port(s), coherence is maintained in all or a subset of {2, 3} among the first PUSCH DM-RS port(s), coherence is maintained in all or a subset of {4, 5} among the first PUSCH DM-RS port(s), and coherence is maintained in all or a subset of {6, 7} among the first PUSCH DM-RS port(s).

13. The claim according to claim 9, wherein when the at least one TB is one TB, the first PUSCH DM-RS port(s) and the second PUSCH DM-RS port(s) are all PUSCH DM-RS ports indicated by the scheduling information.

14. A terminal comprising:
a processor; and
a transceiver,
wherein the processor is configured to perform:
generating uplink control information (UCI);
receiving, through the transceiver, scheduling information for transmission of a physical uplink shared channel (PUSCH) including at least one transport block (TB);
selecting codeword(s) with which the UCI is to be multiplexed from among codeword(s) according to the at least one TB;
determining first PUSCH demodulation-reference signal (DM-RS) port(s) to be used for transmission of the at least one TB and second PUSCH DM-RS port(s) to be used for transmission of the UCI; and
transmitting, through the transceiver, the PUSCH in which the selected codeword(s) and the UCI are multiplexed by using the determined first PUSCH DM-RS port(s) and second PUSCH DM-RS port(s).

15. The terminal according to claim 14, wherein the PUSCH is transmitted using five or more layers and corresponds to one sounding reference signal (SRS) resource having eight ports, and each port of the PUSCH is preprocessed identically to each corresponding port in the SRS resource.

16. The terminal according to claim 14, wherein the at least one TB includes a first TB and a second TB, the first PUSCH DM-RS port(s) is divided into a first subset including first-first DM-RS port(s) to which the codeword corresponding to the first TB is mapped and a second subset including first-second DM-RS port(s) to which the codeword corresponding to the second TB is mapped, an intersection of the first subset and the second subset is an empty set, and the second PUSCH DM-RS port(s) are the first-first PUSCH DM-RS port(s) or the first-second PUSCH DM-RS port(s).

17. The terminal according to claim 16, wherein coherence is maintained in all or a subset of the first PUSCH DM-RS port(s).

18. The terminal according to claim 16, wherein coherence is maintained in all or a subset of {0, 1, 4, 5} among the first PUSCH DM-RS port(s), and coherence is maintained in all or a subset of {2, 3, 6, 7} among the first PUSCH DM-RS port(s).

19. The terminal according to claim 16, wherein coherence is maintained in all or a subset of {0, 1} among the first PUSCH DM-RS port(s), coherence is maintained in all or a subset of {2, 3} among the first PUSCH DM-RS port(s), coherence is maintained in all or a subset of {4, 5} among the first PUSCH DM-RS port(s), and coherence is maintained in all or a subset of {6, 7} among the first PUSCH DM-RS port(s).

20. The terminal according to claim 16, wherein when the at least one TB is one TB, the first PUSCH DM-RS port(s) and the second PUSCH DM-RS port(s) are all PUSCH DM-RS ports indicated by the scheduling information.
